(19) United States
(12) Patent Application Publication
(10) Pub. No.: US 2006/0219758 A1
(43) Pub. Date: Oct. 5, 2006

(54) Welding of gamma'-strengthened superalloys

(75) Inventor: Zafir Abdo, Orlando, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 11/092,793

(22) Filed: Mar. 29, 2005

(51) Int. Cl. B23K 1/20; B23K 31/02; B23K 35/24

(52) U.S. Cl. 228/206; 228/205; 228/262.5

(57) ABSTRACT

A method of welding γ′-strengthened superalloys. The methods improve the weldability of these superalloys by creating areas having lower amounts of γ′-forming elements, resulting in stronger welds. In one method, a vacuum heat treatment is used to create γ′-depleted zones having reduced amounts of γ′-forming elements. A post weld heat treatment may then be used. In another method, a γ-stabilizing element, such as Cr or Ni, is deposited on the area to be welded. Again, a post weld heat treatment may then be used.

### FIELD OF THE INVENTION

This invention is directed generally to welding alloys, and more particularly to welding γ′-strengthened superalloys.

### BACKGROUND

Nickel base superalloys are extensively used in high temperature applications owing to their excellent high temperature properties and stability. However, welding of nickel base superalloys is proving to be a challenge due to the formation of cracks at the welding temperature and/or upon post weld heat treatment. These cracks are caused by the introduction of stresses imposed on the joint from two main sources. The first is the thermal stress caused by temperature variation in the weld region, the heat affected zone (HAZ) and the base substrate. The second source is the stress caused by volumetric change resulting from the γ to γ′ phase transformation. The extent of cracking is exaggerated by the loss of ductility at elevated temperature and weld joint constrains.

The weldability of a specific alloy is particularly dependant on the γ′ volume fraction of the superalloy. For example, solution strengthened nickel base alloys (which by design do not contain γ′) such as IN625 & IN617 are readily weldable. However, the weldability of the these alloys reduces with γ′ volume fraction from low in alloys such as 1N738 & 1N939 (which contain around 40-50% γ′ volume fraction) to very poor in alloys such as (CM247 & MarM002) which contain around 60 to 70% γ′ volume fraction. It is to be noted that the high temperature capabilities of superalloys increases with increasing γ′ volume fraction.

Existing superalloy welding techniques may be grouped into two main groups a) structural welding, where the welded joint yields a minimum of 70% base metal mechanical properties, or b) non-structural welding where the latter resulting joint strength does not exceed 40% of base metal properties. In the latter method, a weaker but more ductile filler material is used to accommodate the stresses imposed on the weld joint and prevent cracking as discussed above. This approach may readily produce crack free joints, however the joint is weak and 60% of base metal capability is compromised and hence is limited in application to locations of low stresses.

In the former method, a combination of pre-weld heat treatments & welding with high preheat are employed to produce structural welds. In high preheat welding an induction coil is used to heat the weld joint and it's proximity to above 2000° F. This high preheat reduces thermal stress due to temperature variation across the weld region by maintaining uniform temperatures. Draw backs of this approach include the difficulty to control the temperature profile induced by preheating, excessive melting of thin sections, time needed for welding, high skill levels needed and hostile welding environment.

Accordingly, what is needed is a method of welding γ′-strengthened superalloys that alleviates the problems of prior art welding of these superalloys. Also what is needed is a method that is effective at welding these γ′-strengthened superalloys in a cost-effective and/or efficient manner.

### SUMMARY OF THE INVENTION

This present invention provides a method for welding γ′-strengthened superalloys. The methods improve the weldability of these superalloys by locally creating areas having lower amounts of γ′, resulting in crack free welds. In one embodiment, the present invention uses vacuum heat treatment to create γ′-depleted zones having reduced amounts of γ′-forming elements such as Al and Ti. A post weld heat treatment may then be used to recover the selected γ/γ′ microstructure.

In an alternative embodiment, a γ-stabilizing element, such as Cr or Ni, is deposited on the area to be welded to help prevent the γ to γ′ phase transformation that results during the weld process. Again, a post weld heat treatment may then be used to recover the selected γ/γ′ microstructure.

These and other embodiments are described in more detail below.

### BRIEF DESCRIPTION OF THE DRAWINGS

Other objects, features and advantages of the present invention will become apparent upon reading the following detailed description, while referring to the attached drawings, in which:

FIG. 1 shows an example of an alloy made according to one embodiment of the present invention and having areas substantially depleted of γ′ elements.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The present invention provides methods of welding superalloys that are γ′-strengthened. Superalloys that are γ′-strengthened include elements that would form γ′ during the welding process. As discussed, as the level of γ′ increases, the superalloy becomes more susceptible to cracks during a welding process such that, during welding of these superalloys, the γ phase is convert to γ′ phase, thereby increasing the γ′ percentage, this transformation leads to volumetric change which in turn applies additional stresses which lead to the formation of cracks. As such, the present invention alters the γ/γ′ balance to weld the superalloy, and then restores the γ/γ′ balance after welding has occurred. As a result, the superalloy has no or fewer cracks at the location of the weld than with prior art methods.

Accordingly, the methods of the present invention involve the steps of treating the areas to be welded in the superalloy to alter the superalloy such that formation of γ′ is reduced, then welding the superalloy, and then, optionally, restoring the original γ/γ′ balance to the superalloy if the original physical characteristics are desired.

As such, in a first step of the present invention, the areas to be welded in the superalloys are pre-treated in a manner to help reduce the γ′ formation during welding. This may be accomplished using any method effective at reducing the total amount of γ′ forming elements to reduce the potential of γ′ formation during a welding process.

In a first embodiment, the areas to be welded are pre-treated by using a step of removing γ′-forming elements from the superalloy. As such, since these areas of the superalloy have a reduced amount of γ′-forming elements, less γ′ material will be formed during the subsequent welding process, thereby reducing the formation of cracks during welding. As used herein, a “γ′-forming element” is any element that, upon the application of heat and cooling, forms a γ′ material. Examples of γ′-forming elements include, but are not limited to, aluminum (Al), titanium (Ti), or a combination thereof. Nevertheless, the methods of the present invention contemplate that any γ′-forming element in a superalloy may be removed to help ensure a reduced formation of the γ′ phase during welding.

Any step that is capable of removing γ′-forming elements from a superalloy may be used in the present invention. In one embodiment, a vacuum heat treatment process is used to remove γ′-forming elements. In this embodiment, the areas to be welded are placed in a vacuum or in an area of reduced pressure of 10E-4 barr or lower and then subjected to a heat treatment step to remove an amount of γ′-forming elements such as Al & Ti. The temperature may be in the 2000° F. range. The length of the heat treatment step may be anywhere from about 4 hours and above. In general, the longer the heat treatment step stays at a given temperature, the more of the γ′-forming element that will be removed up to a certain undetermined value.

In one embodiment, the amount of γ′-forming elements are reduced in an amount of 10 mole % as compared to the original amount of γ′-forming elements in the superalloy. In another embodiment, the amount of γ′-forming elements are reduced in an amount of 20% as compared to the original amount of γ′-forming elements in the superalloy.

Once the amount of γ′-forming elements have been removed from the areas to be welded, the superalloy is subjected to a welding step. One example of a welding step is fusion welding. As used herein, “fusion welding” is intended to include arc welding, electron beam welding, flash welding, plasma & laser welding, or a combination thereof.

Once the welding step has been completed, the areas of the superalloy that were welded may be returned to the original γ/γ′ balance of the superalloy using a post-weld heat treatment step. Again, as the application of heat converts the γ phase into γ′ phase, the heat treatment step may be selected such that the original γ/γ′ balance, or close to the γ/γ′ balance, is achieved using the heat treatment step. Examples of heat treatment steps that may be used in the present invention include, but are not limited to, solution treatment and aging, or a combination thereof. It is also to be understood that this additional heat treatment step is not required if the original γ/γ′ balance for the welded areas of the superalloy is not desired. Alternatively, the heat treatment step may be used to create a new γ/γ′ balance such that the areas that were welded have different properties than the original superalloy.

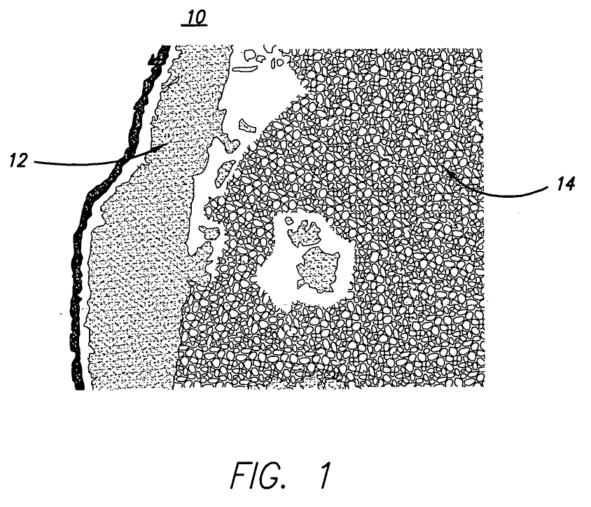

One example of such a superalloy may be seen in FIG. 1. In this Figure, the superalloy 10 has been treated to remove γ′-forming elements from an area to be welded. After welding, the superalloy 10 includes a zone 12 that is depleted in regards to γ′ elements, whereas the areas that were not treated 14 show a γ/γ′ microstructure.

In an alternative embodiment, the present invention may, instead of removing γ′-forming elements, add a γ-stabilizing material to the areas to be welded followed by heat treatment to diffuse the γ forming phase into the material. As such, during the welding process, the γ-stabilizing material stabilizes the γ phase, thereby reducing the conversion of the γ phase to γ′ phase. As a result, there is a lower γ′ percentage in the areas to be welded and the resulting welds have lower incidences of crack formation.

As used herein, a “γ-stabilizing material” is any material that is capable of stabilizing the γ-phase such that, during a welding process, a lesser amount of γ is actually transformed into γ′ materials. Examples of γ-stabilizing materials that may be used in the present invention include, but are not limited to, nickel, chromium, or a combination thereof.

The γ-stabilizing material may be added to the areas to be welded using any suitable process. Examples of suitable processes include, but are not limited to, a deposition process, a plating process, a coating process, or a combination thereof. The amount of γ-stabilizing material that may be added may vary depending on a variety of factors including, but not limited to, the superalloy being welded, the γ/γ′ balance of the superalloy, the γ-stabilizing material used, the welding process to be used, or a combination thereof.

The surfaces are then welded using a welding process. While it may be possible to use a variety of different welding processes after the addition of the γ-stabilizing material, in one embodiment, it would be beneficial to use a low heat input welding process to help reduce the chance that the γ phase will be converted to γ′ during the welding process. One example of a low heat input welding process is a micro plasma welding process, micro TIG or low heat input lasers.

Again, as with the previous embodiment, once the welding step has been completed, the areas of the superalloy that were welded may be returned to the original γ/γ′ balance of the superalloy using a post-weld heat treatment step. Again, this heat treatment step may be selected such that the original γ/γ′ balance, or close to the γ/γ′ balance, is achieved using the heat treatment step. It is again to be understood that this additional heat treatment step is not required if the original γ/γ′ balance for the welded areas of the superalloy is not desired. Alternatively, the heat treatment step may be used to create a new γ/γ′ balance such that the areas that were welded have different properties than the original superalloy.

The methods of the present invention may also be used in a method for repairing an article, such as a turbine component, that contains one or more superalloys.

Another method is to chemically remove the γ′ forming elements, such as Al and Ti, from the surfaces to be welded. The chemical treatment might be immersing in an acid bath with controlled temperature, electro-etching or vapor cleaning. In electro-etching, the material is immersed in a chemical bath and an electrical current is run through the material. Vapor cleaning\etching is similar to chemical etching/stripping except it uses a flow of gaseous chemical instead of immersion in a liquid bath.

Another method of Al (γ′ former) removal is to heat treat in air environment to oxidize the surface and form aluminum oxide which is them mechanically removed via polishing or light machining. This removes a very small layer at a time and the process needs to be repeated automatically.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A method for welding γ′-strengthened superalloys comprising:
pre-treating at least one area of the superalloy to be welded to reduce the formation of γ′ materials during a welding process; and
welding the superalloy in the at least one area to be welded.

2. The method of claim 1, wherein the superalloy is pre-treated to remove a portion of γ′-forming elements from the at least one area to be welded.

3. The method of claim 2, wherein at least about 10 mole % of the γ′-forming elements are removed from the at least one area to be welded.

4. The method of claim 3, wherein at least about 20 mole % of the γ′-forming elements are removed from the at least one area to be welded.

5. The method of claim 2, wherein the removal of γ′-forming elements from the at least one area to be welded is accomplished using a vacuum heat treatment step.

6. The method of claim 5, wherein the vacuum heat treatment step is performed at a pressure of less than about 1E-4 barr.

7. The method of claim 2, wherein the removal of γ′-forming elements from the at least one area to be welded is accomplished using a chemical stripping process.

8. The method of claim 7, wherein the chemical process is immersion in an acid bath.

9. The method of claim 7, wherein the chemical process is electroetching.

10. The method of claim 7, wherein the chemical process is vapor cleaning.

11. The method of claim 2, wherein the superalloy has an original γ/γ′ ratio and wherein the method further comprises the step of using a heat treatment step to restore to substantially the original γ/γ′ ratio after the superalloy has been welded.

12. The method of claim 2, wherein the γ′-forming elements are selected from aluminum, titanium, or a combination thereof.

13. The method of claim 2, wherein a fusion welding process is used to weld the superalloy in the at least one area to be welded.

14. The method of claim 1, wherein a γ-stabilizing element is added to the at least one area to be welded.

15. The method of claim 14, wherein the γ-stabilizing element is added using a deposition process, a plating process, a coating process, or a combination thereof.

16. The method of claim 14, wherein the γ-stabilizing element is selected from nickel, chromium, or a combination thereof.

17. The method of claim 14, wherein the superalloy has an original γ/γ′ ratio and wherein the method further comprises the step of using a heat treatment step to restore the original γ/γ′ ratio after the superalloy has been welded.

18. The method of claim 14, wherein a low heat input welding process is used to weld the superalloy in the at least one area to be welded.
